(19) United States
(12) Patent Application Publication
(10) Pub. No.: US 2024/0185182 A1
(43) Pub. Date: Jun. 6, 2024

(54) CENTRALIZED SAAS PLATFORM FOR A&RS, RECORD LABELS, DISTRIBUTORS, AND ARTISTS TO EXPLORE UNRELEASED PRODUCTION FROM SONGWRITERS

(71) Applicant: Brittany Elizabeth Perry, Los Angeles, CA (US)

(72) Inventor: Brittany Elizabeth Perry, Los Angeles, CA (US)

(21) Appl. No.: 18/402,751

(22) Filed: Jan. 3, 2024

(51) Int. Cl. G06Q 10/101; G06Q 50/10

(52) U.S. Cl. CPC G06Q 10/101; G06Q 50/10

(57) ABSTRACT

The present invention provides a novel form of system, method, and computer instructions with the aim of enhancing music production collaboration. The system consists of a first computer host, a database, and a second computer host. Its primary objective is to serve Songwriters, Artists, and Music Executives in the A&R (Artist and Repertoire) process of creating music. By uploading their unreleased production to the platform, Songwriters can allow Music Executives and Artists to search for production for future musical projects. In turn, Artists can communicate to Songwriters their current creative brief. Songwriters can keep track of which songs are being used by the A&R and the artists. To access the platform, Songwriters can select from subscription tiers. Music executives and Musicians can use this invention to search for new music for the artists they work with, and they can sign up for the platform via a subscription service.

### PRIOR ART

Collaborating with fellow musicians can prove to be an advantageous pursuit for a variety of reasons. Musicians are often proficient in different aspects of music such as playing multiple instruments, reading sheet music, understanding music theory, composing melodies and lyrics, orchestration, and production. They may also possess unique backgrounds, artistic visions, influences, and preferences which contribute to a more dynamic and enriching collaborative experience.

In addition, remote collaboration may be a more suitable option for certain musicians, such as those who are scattered across different geographical locations, have conflicting schedules, or prefer to work independently.

Despite the availability of numerous music collaboration platforms, it is common for these platforms to have limited functionality. For instance, they may only enable contributors to upload audio files as tracks with basic signal processing capabilities such as adjusting signal amplitude or cutting, copying, and pasting sections of the signal.

However, certain musical collaborations may necessitate more advanced capabilities, such as modifying individual notes, keys, tempos, chord changes, motifs, patterns, timbre, and more. Contributors may need to change instrumentation, transpose melodies, insert individual notes, analyze chord progressions, synchronize multiple contributions, and access many other features. It would be tremendously beneficial for such platforms to offer these advanced capabilities as they would significantly enhance the collaborative experience and enable musicians to create more complex and intricate pieces of music.

By looking at prior art, multiple advancements have been seen in music collaborative environments that provide unique features in their own domain. For instance, a U.S. Pat. No. 4,960,031 referring to Method and apparatus for representing musical information. The method for electronically processing and storing musical information involves separating the musical information into a plurality of segments, each representing some portion of a measure, and assigning a sequential time dimension value to each segment. The musical information is also separated into plurality of channels, with each channel representing a sound source and having a sound dimension value assigned to it. The musical information for a given channel and segment is stored in a memory array by associating the musical information corresponding to a given channel and segment with the memory array node specified by the time dimension value and sound dimension value assigned to the given channel and segment.

A U.S. Pat. No. 5,886,274A relates to system and method for generating, distributing, storing, and performing musical work files. The composition and playback system includes a sound bank containing at least one instrument sound, an input device for receiving music control signals, a sequencer coupled to the input device for storing the music control signals, and a work manager coupled to the sound bank and to the sequencer for generating a musical work file containing the music control signals and at least a portion of the sound bank. The system further includes a synthesizer engine coupled to the input device for processing the music control signals based on the instrument sounds contained in the sound bank, a mixer coupled to the synthesizer engine for mixing effects with the processed music control signals, and a speaker system coupled to the mixer for converting the mixed music control signals to sound.

A U.S. Pat. No. 6,175,872B1 relates to collaborative environment for synchronizing audio from remote devices. The apparatus and software systems are disclosed that allow real-time interactive playing of musicians each at remote sites from each other. The remote sites are interconnected over a local communications network or a wide area network like the Internet. The apparatus is connected to music synthesizers that accept streams of MIDI data for playing or generate streams of MIDI data by playing. The streams of MIDI data are bundled by a MIDI management system into transfer control protocol packets, such that the packets of MIDI data may be transferred over the communications network as or within the transfer control packets. In addition, the networked, remote computer systems are synchronized to a standard clock which is appended to the MIDI data packets, and additionally, the network delay is calculated and also appended to the MIDI data packets. In this manner the local musician can receive the MIDI data packets from the remote sites where musicians are playing and in real-time play with them. The present invention allows other data bases of music to be interrogated and the music therein retrieved for local use, storing and/or editing. The invention allows the received MIDI data from remote sites to be precisely time positioned within the local memory as if on separate tracks like a multi-track tape recorder for later or real-time playing and/or editing.

A WO patent 2,010,018586A2 relates to method and a system for real time music playback synchronization, dedicated players, locating audio content, following most listened-to lists and phrase searching for sing-along. The method for language translation of lyrics by subscribers and a database containing synchronization tables. One method includes accessing by subscribers to original lines in English, e.g., filling in the language translation and vocally recording each line, thereby providing an automatic language lesson to any language from any language that has previously been translated. Another embodiment enables subscribers to play music produced by a particular musical artist on a music player dedicated to the artist. The method includes choosing a musical artist to whom said music player will be dedicated, bundling a number of songs of said artist into a music player dedicated to said artist, displaying a listing of the artist's productions and enabling the artist to communicate directly with his portion of the subscribers and enabling a group of local subscribers having playback devices to synchronize a display of song lyrics to a timer.

Attempts are previously undertaken to provide various advancements and novel features; however, their traditional structure and setup methods pose significant obstacles to their user-friendliness. These preceding systems possess inherent constraints that make them less relevant and user-convenient in the constantly evolving landscape of the contemporary age.

None of the previous inventions and patents, taken either singly or in combination, is seen to describe the instant invention as claimed. Hence, the inventor of the present invention proposes to resolve and surmount existent technical difficulties to eliminate the shortcomings of prior art.

### BACKGROUND OF THE INVENTION

Signed Musicians use a process known as Artist and Repertoire to create new bodies of musical works for commercial release. They work with a representative of the company they are in partnership with who are referred to as an “A&R” who is a Music Executive. A&Rs are paid by the company they represent to use their creative instinct and provide guidance by way of providing creative support to artists. Such support can include sourcing and organizing new production ideas for the artist(s) that are assigned to the A&R's roster.

The process in which an A&R or an Artist goes about sourcing new production for a project can vary by executive and artist at each company.

There has been an on-going issue of A&R Executives in search for “hit records” for the artist(s) that they work with.

Record Labels and Distribution Companies spend several hundreds to thousands of dollars on promotion for certain artists' releases at each respective company.

The goal of a Record Label and/or Distribution Company is to garner as much exposure and support for their releases as each company possess the rights to collect a portion of the revenue generated from the commercial success of such releases.

The goal of artists when partnering with a company for career support is to be able to create music that resonates with their fan base and grow a financially successful catalogue of their art.

The discovery process of new production from a songwriter by an artist can be difficult as a result of no centralized database existing with creative briefs which include descriptions for the focus of the artist's project.

Artist and A&Rs are forced to put together musical projects from production they have access to instead of being able to access a database of production in a non-marketplace web portal.

Many Artists' careers have begun to stagnate as a result of not have a direct source to search for new production to inspire new musical releases for their catalogue.

The less releases coming from an artist, the less they will make money from the catalogue of their commercially released compositions.

### SUMMARY OF THE INVENTION

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole

The primary desirable object of the present invention is to provide a novel and improved system and method of collaborative creation and handling of music contributions from multiple contributors.

Another object of the present invention is a method that facilitates the collaborative handling of music contributions from multiple collaborators. In one aspect, techniques of the invention can be implemented as a network site, such as a Web portal. The Web portal can utilize audio signal processing, music character recognition technology, and music transcription techniques to provide a collaborative environment for Music projects. Thus, embodiments of the invention can provide a network site for hosting multiple users in collaborative development efforts.

The primary purpose of this invention introduces a non-marketplace database for Songwriters, Artists, and Music Executives to collaborate regarding the A&R (Artist and Repertoire) process of putting together music. It will allow songwriters to upload their unreleased productions to the platform for Music Executives and Artists to search through and find production for future unreleased musical projects. Music executives and artists will be able to keep track of their favorite songwriters as to new ideas that they're uploaded to the platform, and updates regarding songs that the executive may have favored, or that were put on hold by either party. Songwriters will be able to message both artists and executives with new playlist pitches for the current creative briefs listed on their respective profiles.

It is also the objective of the invention to provide an organized and cohesive platform for production discovery in collaboration with the Artist and Repertoire process for musicians.

It is also the objective of the invention to provide a smart system that allows for the mass sharing of unreleased productions by songwriters for mass access amongst record executives.

It is a further aspect of the present invention to provide new and improved software developed from complex and reliable algorithms that allow record executives to keep track of their favorite songwriters and also allow them to upload to the platform, provide updates regarding songs that the executive may have favorited, or that was put on hold by either party.

Thus, it is the objective to provide a new and improved method of collaborative music production platform. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 the image of an users' log in page

FIG. 1 the image of a user's signing up for a new account

FIG. 2 the image of requested personal information required for songwriters

FIG. 2a the image of requested personal information required for executives

FIG. 2b the image of email verification request

FIG. 3 the image of an users' personalized dashboard

FIG. 3a represents the built-in search feature of the dashboard page

FIG. 4 the layout of the upload music page

FIG. 5 the layout of the playlist(s) page

FIGS. 6 &6a the layout of contacts list

FIGS. 7 & 7a the layout of the built-in messaging feature with categorization

FIG. 7b the image of a user's message center with music playback integration

FIG. 7c the image of a user's message center with music playback integration and playlist integration

FIG. 8 represents the built-in music search feature

FIG. 8a the image of a user putting a musical work on hold

FIG. 8b the image of a musical works' individualized page with personalized metrics

FIG. 8c the layout of the “history of downloads” metric for a musical work

FIGS. 8d & 8e the process of reserving musical works

FIG. 9 the layout of an A&R's profile on the platform

FIGS. 9a & 9b the image editing an executive profile

FIG. 9c the layout of adding new artist to an executives' roster

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements through.

As used herein, an “A&R”, a “Songwriter”, and an “Artist”. A&R refers to a representative from the music label (Music Executive) who is responsible to organize projects with the artist assigned to their roster. A songwriter is a person who creates the production and write lyrics for a composition. An “Artist” is the talent performing such composition.

The present invention is directed to a software-based tool (e.g. an application) that enables the A&R and Artists to search and find new composition (i.e. a track, loop, song with a topline) for the purpose of future commercial release. The word “composition” may be used interchangeably throughout with any (or multiple) of the examples provided herein.

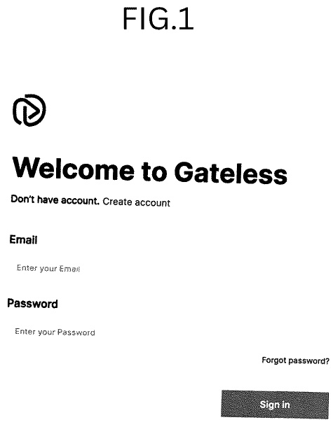

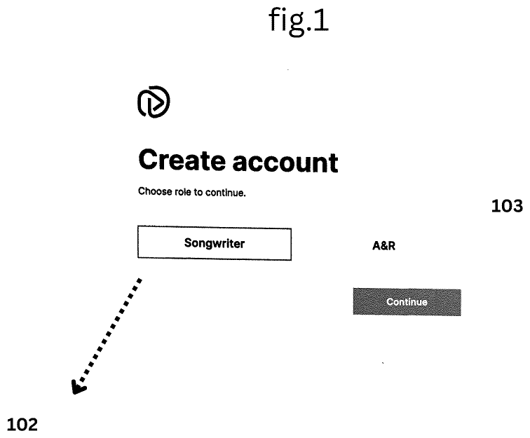

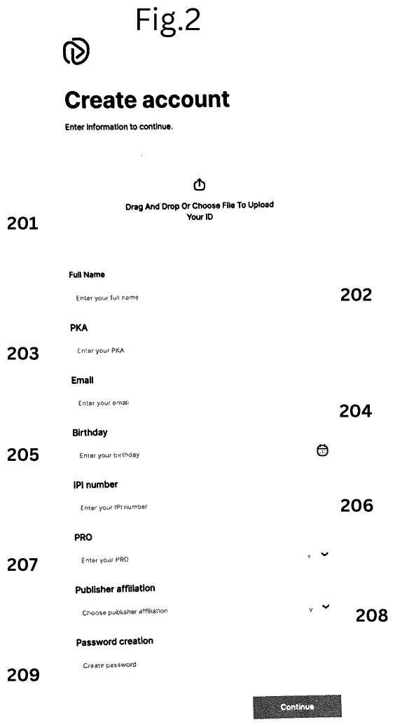

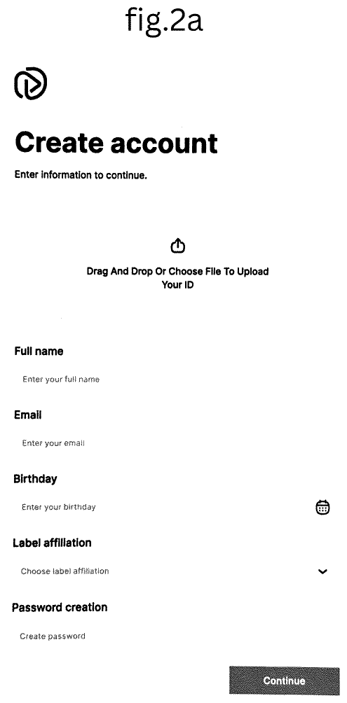

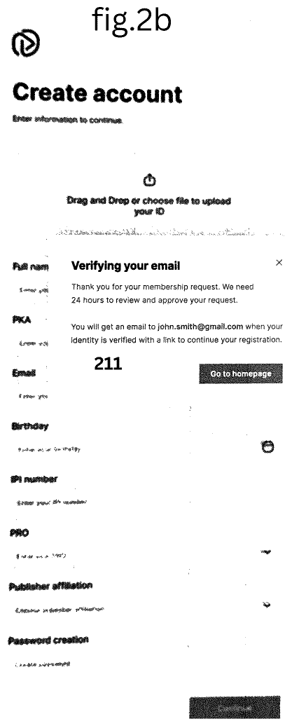

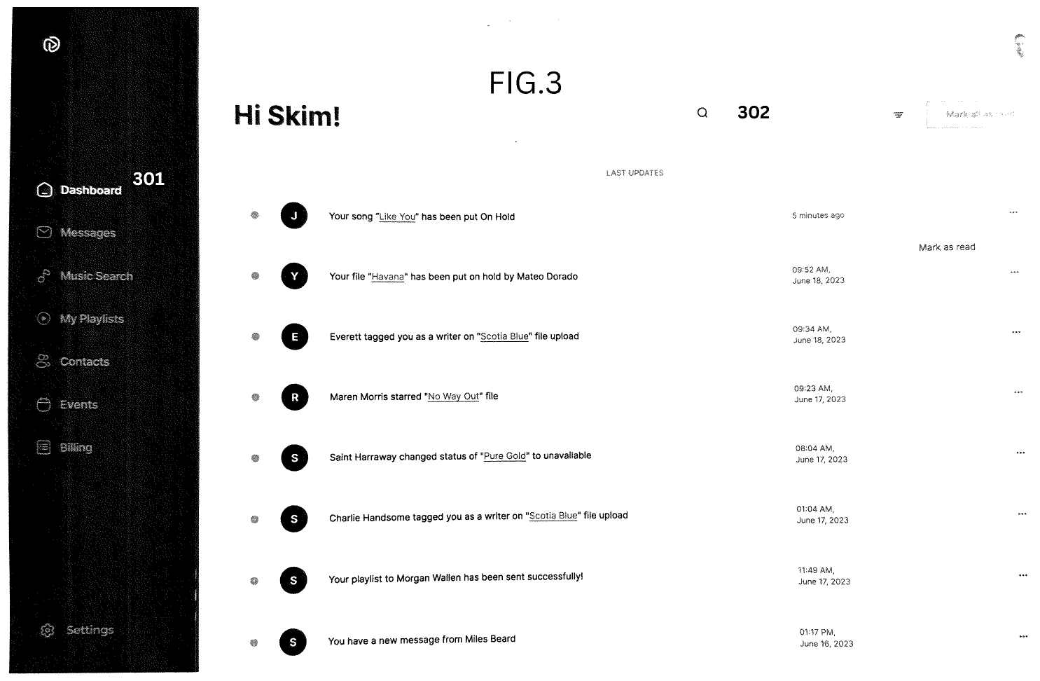

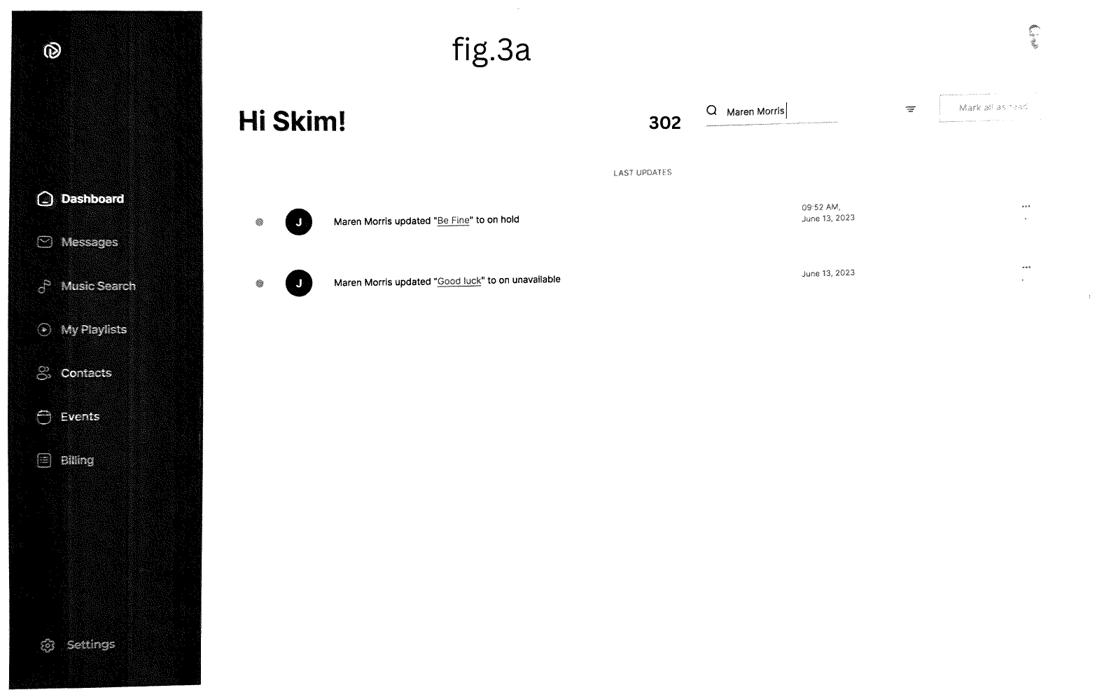

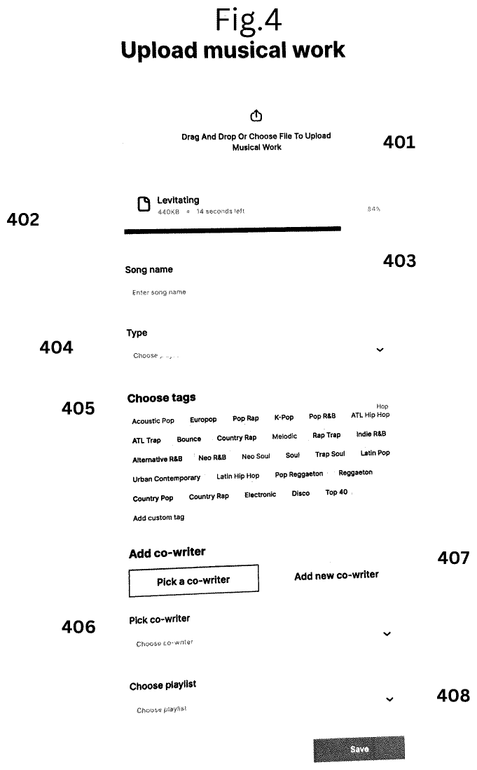

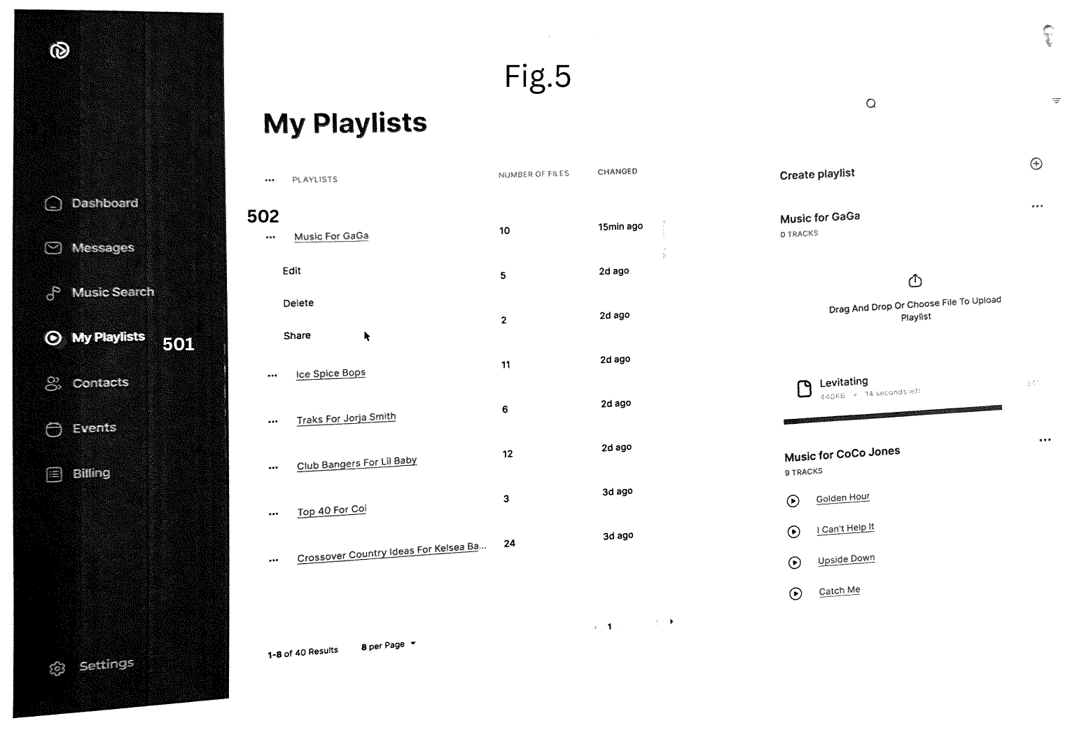

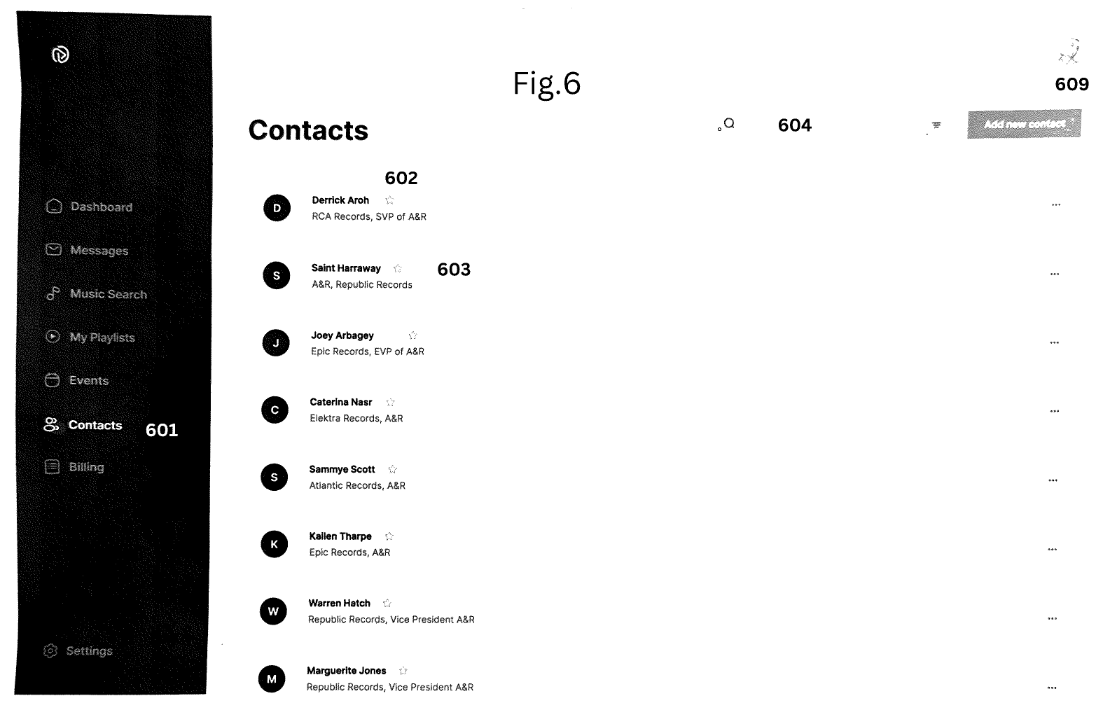

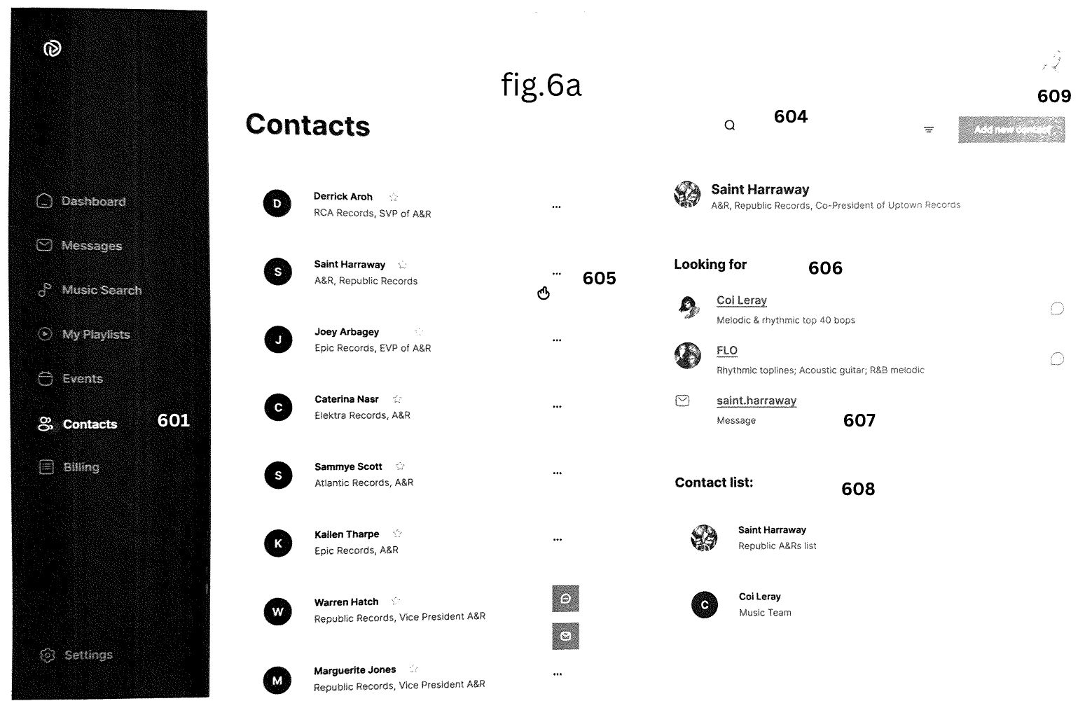

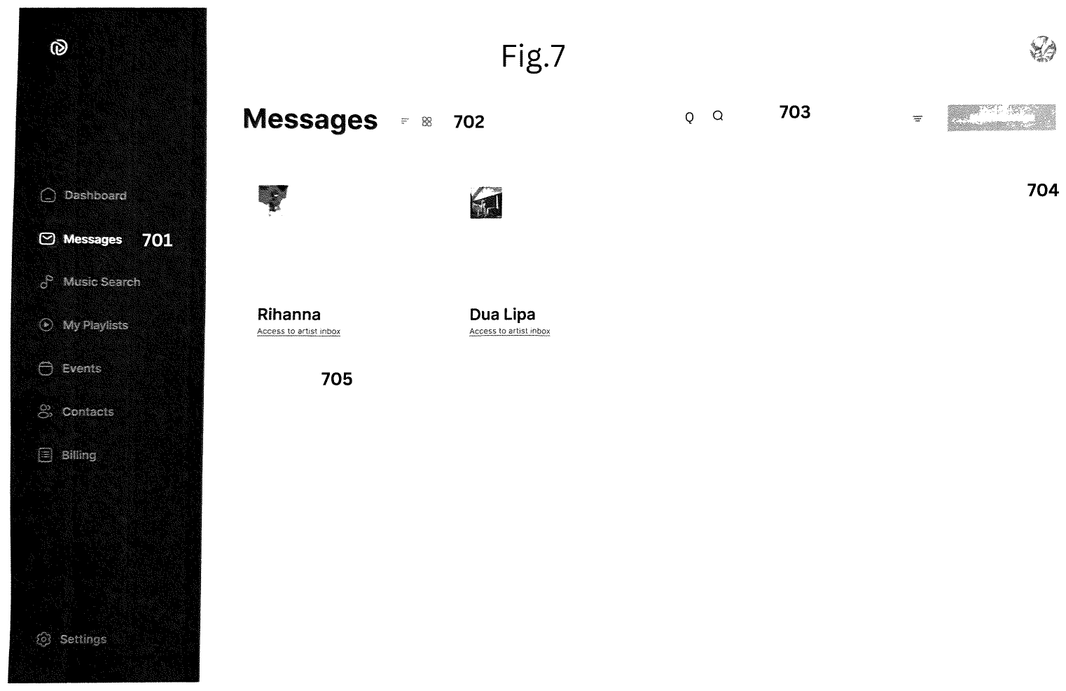

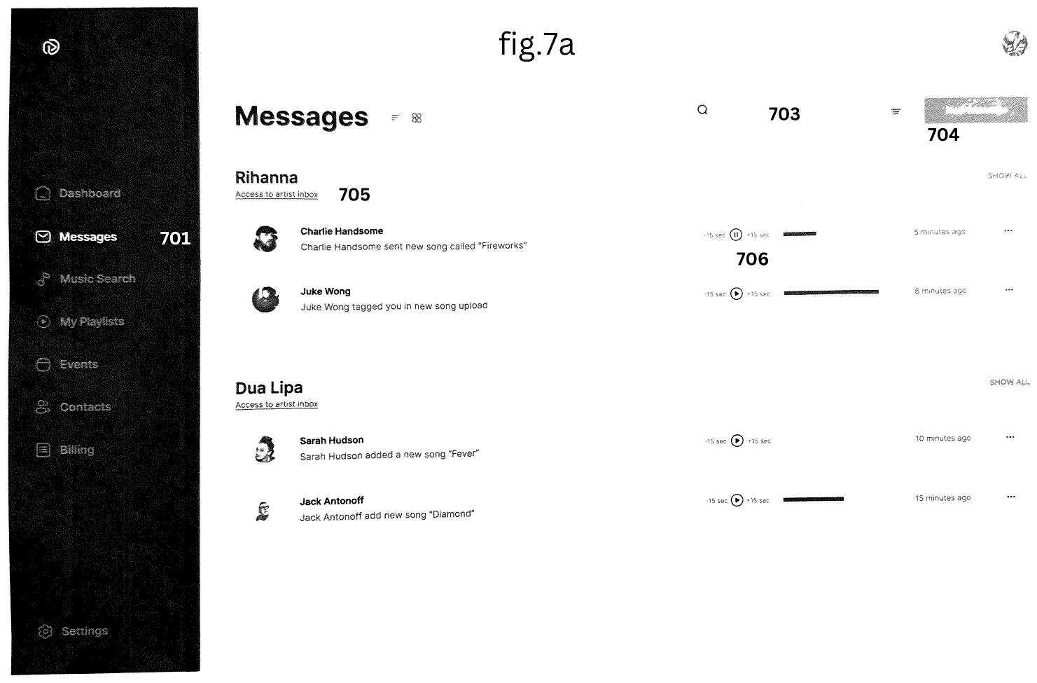

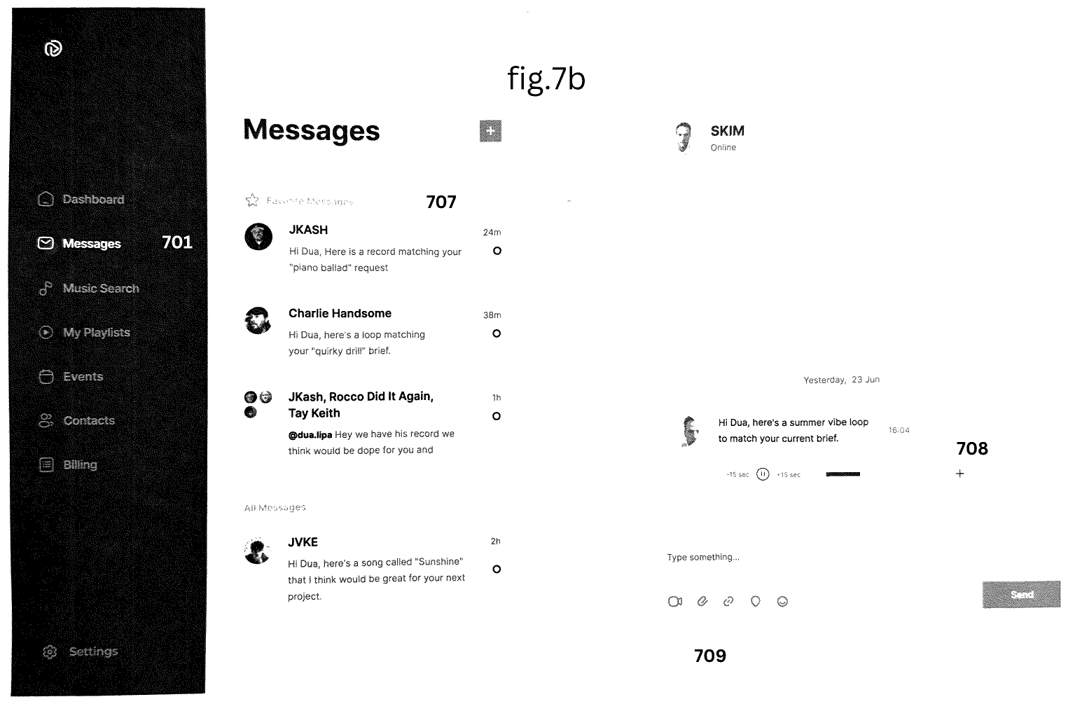

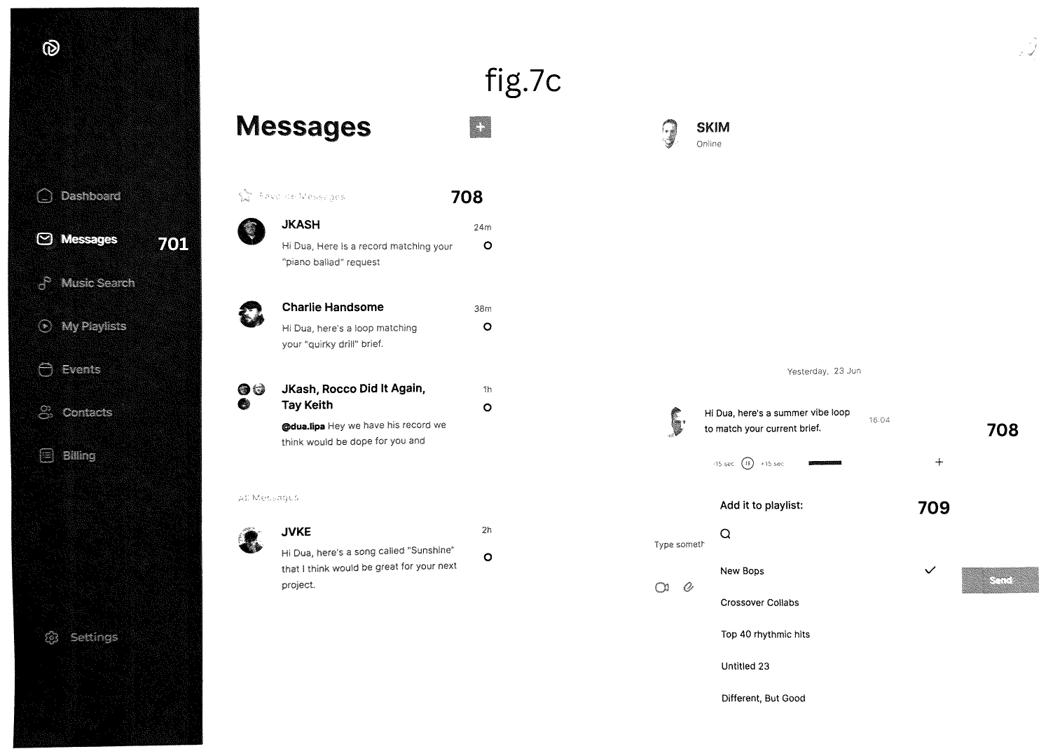

A first embodiment of the platform is illustrated in FIG. 1. If the user is not already a member of the platform. The user will choose whether they are a songwriter, artist or music executive 102. The user will then be prompted to provide personal credentials in order to generate an account FIG. 2. The user will be prompted to verify their email before account creation 211. Once approved, the user will sign into the platform FIG. 1. The user will be granted access to a dashboard that will keep them informed on progress of musical works of interest and search for specific notifications 302. Certain users will have the ability to upload music work 401 to the platform in which they can categorize by type of file 404, identifying genre and/or mood tags 405, identify any additional co-writers of such work 407, and ability to add to a playlist 408. The user will be able to categorize and edit playlists on the platform 502

By selecting the contacts tab 601, the user will be able to search for contacts of fellow artists and music executives 604. Selecting a corresponding profile 605 will populate contact information such profile and a reference of creative briefs 606. Users will be able to save the contact 609 to their own personal contact lists 608.

Music executives will be able to access the inbox of the Artist that they are assigned to manage 705. Music Executive users will be able to search through messages 703, create new messages 704, Review audio files 706, favorite messages 707, Add music from messages 708 straight to playlist 709.

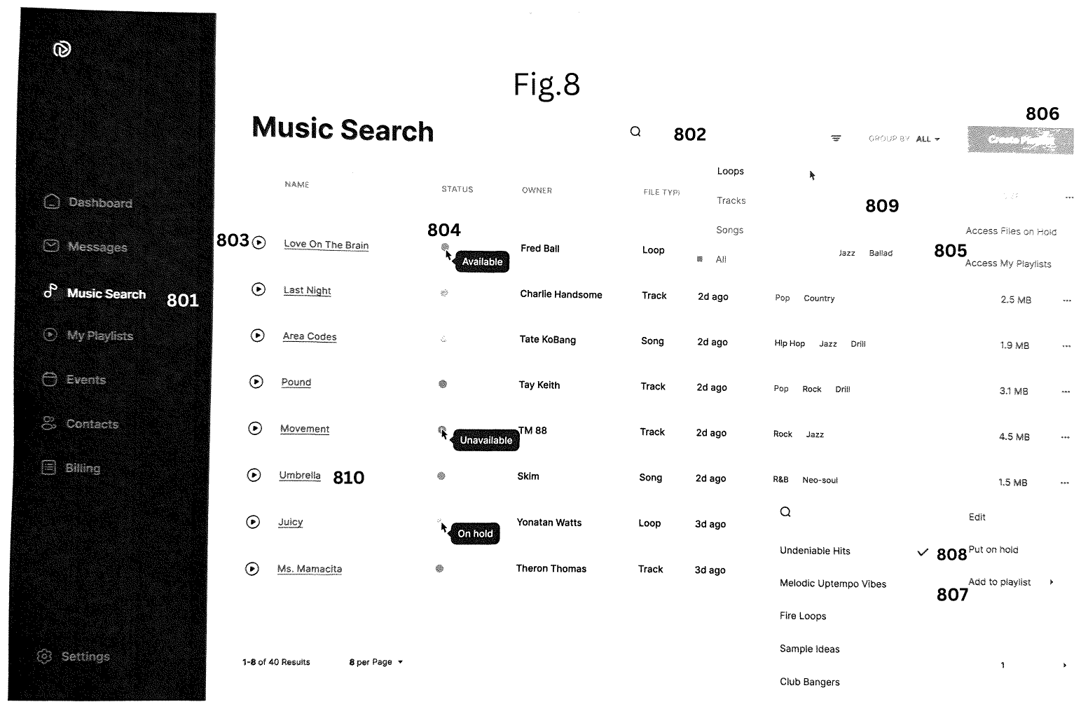

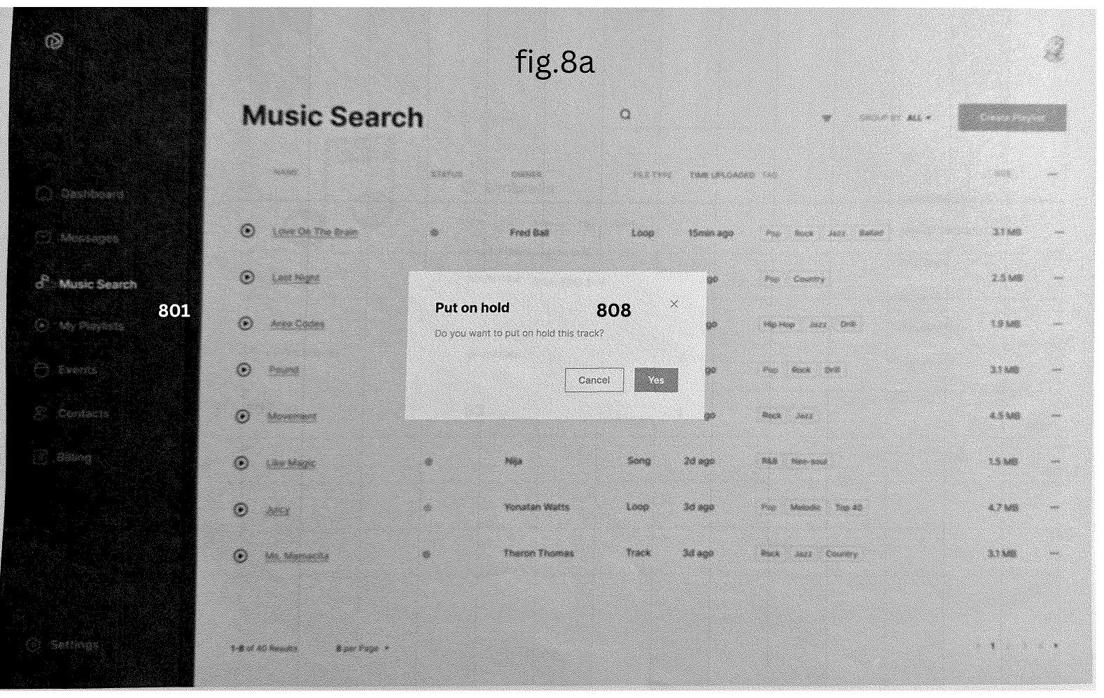

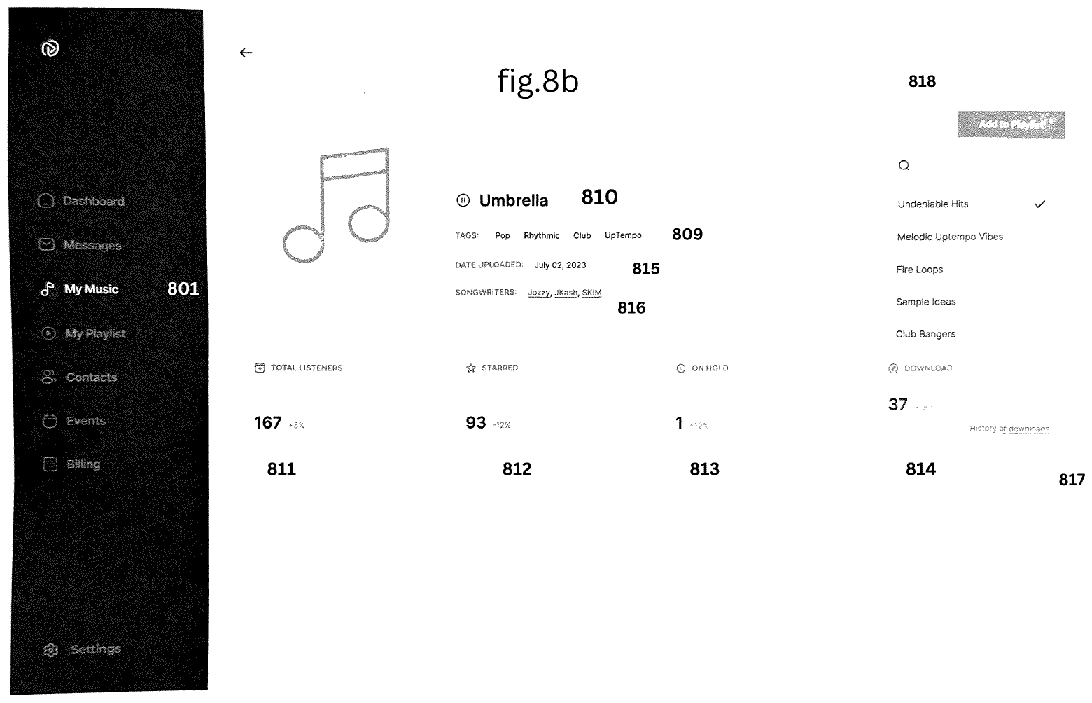

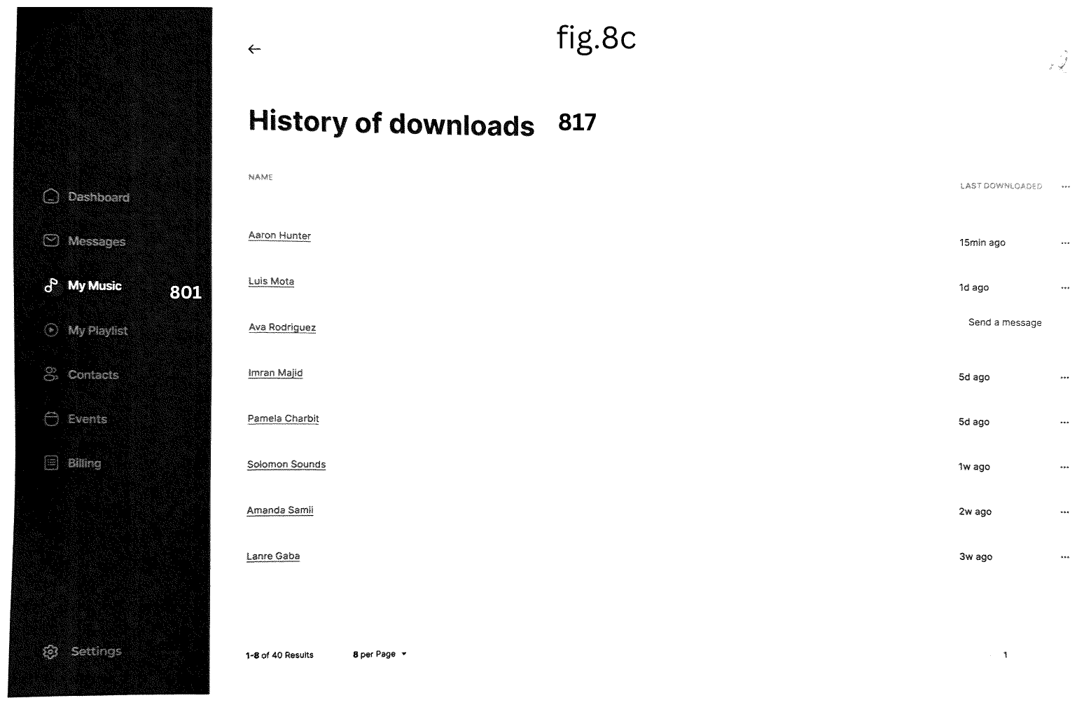

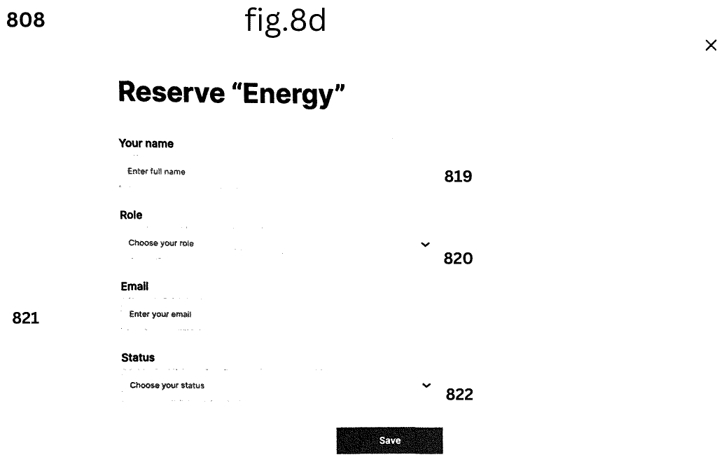

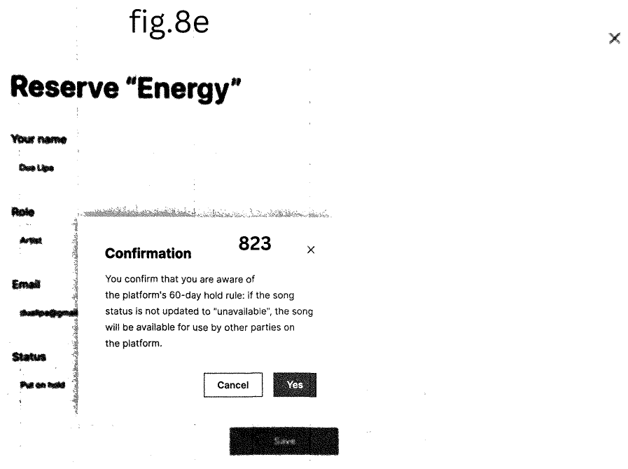

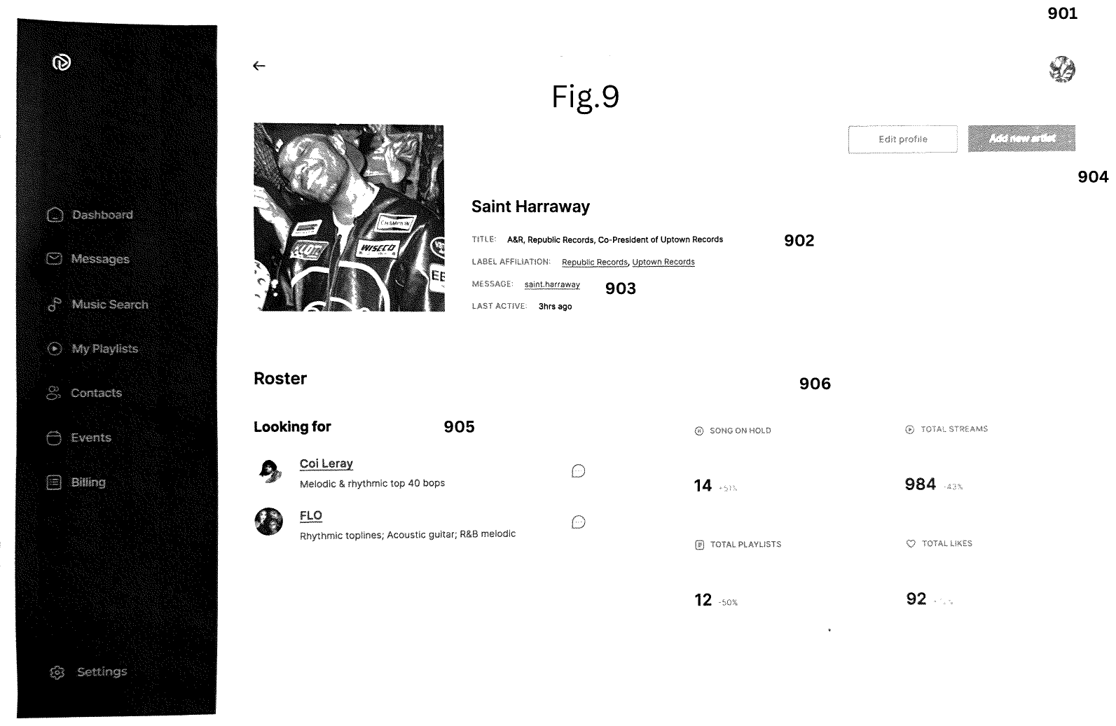

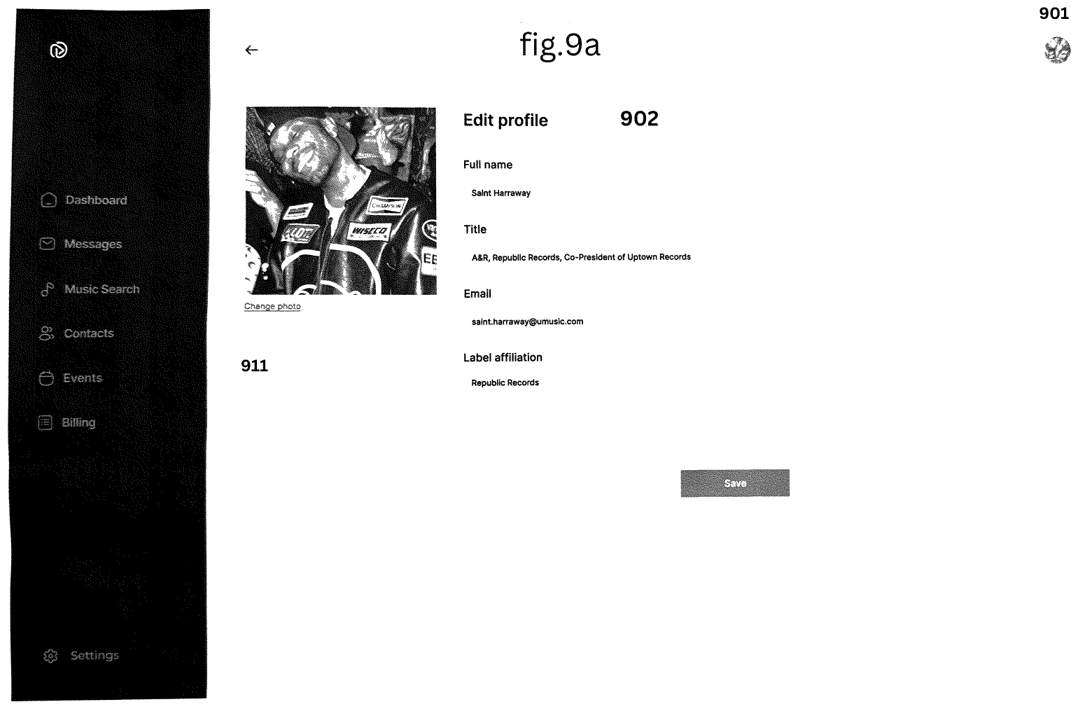

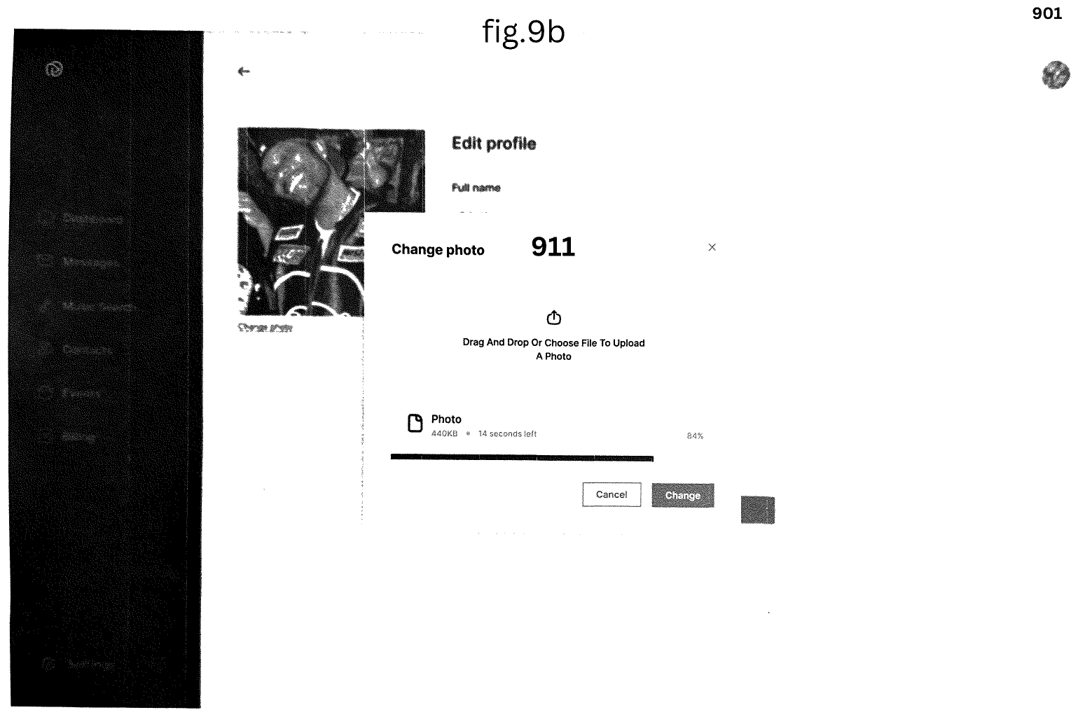

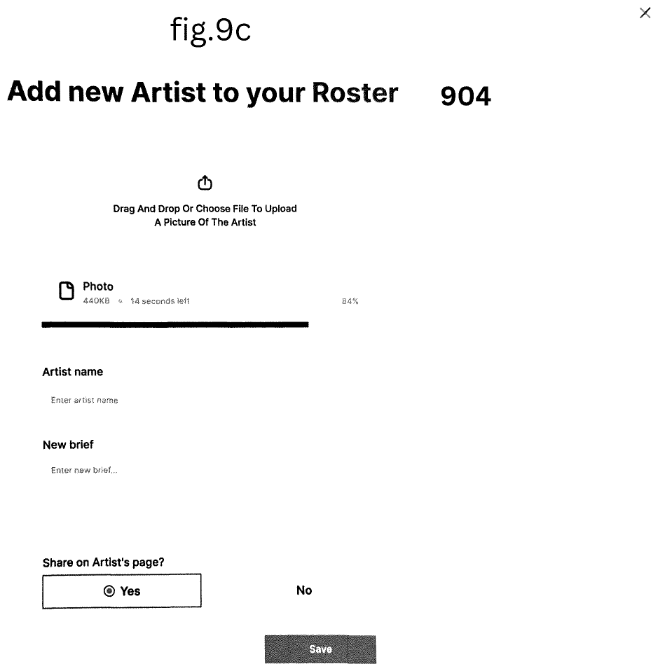

Selecting the Music Search tab 801, Music executives and artists will have access to the built-in music search feature in which they can search for musical works 802, play files 803, create a new playlist 806, add to existing playlists 807, place files on hold 808, and receive status updates 804. Music search has shortcuts to access playlists and files on hold 805. Selecting the hyperlink of a file 810 will take you to the page of the file FIG. 8b. Statistics included on this page will be total listeners 811, how many times it was favorited 812, how many people have it on hold how many people have it on hold 813 and how many downloads have occurred 814 including a history of downloads 817. Users will be able to see when the file was uploaded 815 and the type of tags associated with the file 809 In addition to any other co-writers of the file 816. Users may also add file to a playlist from this page 818. Shall the user want to reserve an uploaded work 808, the selection put on hold shall be chosen and the user will be instructed to input their credentials including name 819, role 820, email 821, and employee status 822 to reserve within in system. Users will then be presented with the notice to confirm reservation 823.

Selecting the icon of the user at the top of the page 901, will bring the user to their public page. This page includes key information regarding affiliation 902, messaging hyperlinks 903, creative briefs (if relevant for the type of profile) 905 and statistics surrounding their time on the platform 906. Music Executives, Artists, and Songwriters will be able to edit their profile 902. Music Executives will have the opportunity to add new artist to their profile with corresponding briefs 904.

We claim:

1. A computer-implemented apparatus for a collaborative tool connecting multiple music entities through a single platform comprising:
receiving a music contribution on a portal, the music contribution comprising a set of music elements and the portal being accessible over the network;
reviewing a plurality of collaboration opportunities on the portal over the network, each of the plurality of collaboration opportunities relating at least in part to the music contribution, and,
wherein at least a first portion of the plurality of collaboration opportunities is from a first-user workstation, and at least a second portion of the plurality of collaboration opportunities is from a second-user workstation.
As per claim 1, the system will provide an interface allowing Songwriters, Artists, Music Executives, Record Labels, and Distribution Companies to collaborate regarding the Artist and Repertoire process of putting together music.
As per claim 1, the system will allow songwriters to upload their unreleased production to the platform for Music Executives and Artists.
As per claim 1, the system allows music executives and artists to search through and find production for future unreleased musical projects.
As per claim 1, the system allows artists and music executives to keep songwriters informed as to what they're currently searching for in terms of a creative brief.
As per claim 1, the system allows songwriters to keep aware of which songs are being used by the music executives and the artists with the use of built-in metrics.
As per claim 1, the system will allow users to sign up through a subscription service.
As per claim 1, the system will allow music executives and artists to search for unreleased musical works through a built-in search tool catered to genre and mood of musical work.
